(19) United States
(12) Patent Application Publication
(10) Pub. No.: US 2024/0340675 A1
(43) Pub. Date: Oct. 10, 2024

(54) GROUP CHANNEL STATE INFORMATION (CSI) REPORTING ENHANCEMENT FOR MULTI-RX CHAIN CAPABLE UE

(71) Applicant: Apple Inc., Cupertino, CA (US)

(72) Inventors: Jie CUI, San Jose, CA (US); Yang TANG, San Jose, CA (US); Hong HE, San Jose, CA (US); Xiang CHEN, Campbell, CA (US); Dawei ZHANG, Saratoga, CA (US); Haitong SUN, Cupertino, CA (US); Fangli XU, Beijing (CN); Konstantinos SARRIGEORGIDIS, Sunnyvale, CA (US); Manasa RAGHAVAN, Sunnyvale, CA (US); Qiming LI, Beijing (CN)

(73) Assignee: Apple Inc., Cupertino, CA (US)

(21) Appl. No.: 18/616,664

(22) Filed: Mar. 26, 2024

Related U.S. Application Data
(60) Provisional application No. 63/457,184, filed on Apr. 5, 2023.

(51) Int. Cl. H04W 24/10; H04B 7/06; H04B 17/318; H04B 17/336; H04W 8/22

(52) U.S. Cl. CPC H04W 24/10; H04B 7/0626; H04B 17/328; H04B 17/336; H04W 8/22

(57) ABSTRACT

Aspects are described for a user equipment (UE) comprising two or more transceivers configured to enable wireless communication with a first base station, and a processor communicatively coupled to the two or more transceivers. The processor is configured to measure a first reference signal and a second reference signal during a measuring period to determine a first measuring result of the first reference signal and a second measuring result of the second reference signal. The processor is further configured to generate one or more reports that include the first measuring result and the second measuring result, wherein the one or more reports indicate that the first measuring result is associated with the second measuring result in time. The processor is further configured to transmit the one or more reports to the first base station.

### CROSS REFERENCES

This application claims the benefit of U.S. Provisional Application No. 63/457,184 filed Apr. 5, 2023, titled “GROUP CHANNEL STATE INFORMATION (CSI) REPORTING ENHANCEMENT FOR MULTI-RX CHAIN CAPABLE UE,” the content of which is herein incorporated by reference in its entirety.

### BACKGROUND

### Field

The described aspects generally relate to a group based channel state information (CSI) reporting procedure for new radio (NR) systems.

### SUMMARY

Some aspects of this disclosure relate to systems, apparatuses, and methods for implementing a group based CSI reporting procedure for NR systems. For example, the systems, the apparatuses, and the methods are provided for reporting measurements of a plurality of reference signals as a group.

Some aspects of this disclosure relate to a user equipment (UE) comprising two or more transceivers configured to enable wireless communication with a first base station, and a processor communicatively coupled to the one or more transceivers. The processor is configured to measure a first reference signal and a second reference signal during a measuring period to determine a first measuring result of the first reference signal and a second measuring result of the second reference signal. The processor is further configured to generate one or more reports that include the first measuring result and the second measuring result, wherein the one or more reports indicate that the first measuring result is associated with the second measuring result in time. The processor is further configured to transmit the one or more reports to the first base station.

Some aspects of this disclosure relate to a method of operating a UE. The method comprises measuring a first reference signal and a second reference signal during a measuring period to determine a first measuring result of the first reference signal and a second measuring result of the second reference signal. The method further comprises generating one or more reports that include the first measuring result and the second measuring result, wherein the one or more reports indicate that the first measuring result is associated with the second measuring result in time. The method further comprises transmitting the one or more reports to a first base station

Some aspects of this disclosure relate to a base station comprising a transceiver configured to enable wireless communication with a UE and a processor communicatively coupled to the transceiver. The processor is configured to transmit a configuration message to the UE. The configuration message configures the UE to report a first measuring result of a first reference signal and a second measuring result of a second reference signal measured in a measuring period. The processor is further configured to receive, using the transceiver, one or more reports that include the first measuring result and the second measuring result, wherein the one or more reports indicate that the first measuring result is associated with the second measuring result in time. The processor is further configured to transmit, using the transceiver, a downlink resource assignment to the UE, wherein the downlink resource assignment assigns a first downlink resource set associated with the first reference signal and a second downlink resource set associated with the second reference signal to the UE.

This Summary is provided merely for the purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example system implementing a group based CSI reporting procedure for NR systems, according to some aspects of the disclosure.

FIG. 2 illustrates a block diagram of an example system of an electronic device for the reference signal configuration procedure, according to some aspects of the disclosure.

FIG. 3 illustrates an example method of the group based CSI reporting procedure, according to aspects of the disclosure.

FIG. 4 illustrates an example of a combined CSI report, according to aspects of the disclosure.

FIG. 5 illustrates examples of separate CSI reports, according to aspects of the disclosure.

FIG. 6 illustrates an example method of the group based CSI reporting procedure at a UE, according to aspects of the disclosure.

FIG. 7 illustrates an example method of the group based CSI reporting procedure at a base station, according to aspects of the disclosure.

FIG. 8 is an example computer system for implementing some aspects of the disclosure or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some aspects of this disclosure relate to systems, apparatuses, and methods for implementing a group based channel state information (CSI) reporting procedure for NR systems. For example, the systems, the apparatuses, and the methods are provided for reporting measurements of a plurality of reference signals as a group.

In some aspects, a base station can communicate with a UE via downlink (DL) channels, such as one or more physical downlink shared channel (PDSCHs). The base station can assign a PDSCH to the UE based on channel state information. For example, the base station can transmit a reference signal, such as a channel station information reference signal (CSI-RS) or a synchronization signal block (SSB) signal, to the UE. The reference signal may be quasi co-located (QCLed) with a PDSCH. The UE can measure the reference signal received and report a measurement result to the base station. The base station then determines whether to assign the PDSCH to the UE based on the measurement result. For example, if the measurement result is above a predetermined threshold, the base station can assign the PDSCH to the UE.

In some aspects, the base station can assign a PDSCH from a plurality of PDSCH candidates to the UE. For example, the base station can transmit a first reference signal and a second reference signal to the UE. The first reference signal may be QCLed with a first PDSCH and the second reference signal may be QCLed with a second PDSCH. The UE then measures the first and the second reference signals and reports them to the base station. The base station may determine to assign the first PDSCH based on the report from the UE. For example, the report may indicate that the first reference signal has a higher reference signal received power (RSRP) or a higher signal-to-interference-plus-noise ratio (SINR) compared with the second reference signal.

In some aspects, the UE may be capable of receiving from more than one base stations at the same time. For example, the UE may include two receiving chains that can receive and process signals from at least two base stations at the same time. In such a case, the UE reports such a capability to the first base station or a network controller via the first base station. Based on the UE capability, it is possible to assign a PDSCH associated with the first base station and a PDSCH associated with the second base station to the UE so that the UE can receive via the assigned PDSCHs from the first and the second base stations at the same time. However, there may be more than one PDSCHs to be assigned for each base station. For example, there may be a first set of PDSCHs associated with the first base station and a second set of PDSCHs associated with the second base station. In such a case, the first base station or the network controller can select a first PDSCH out of the first set of PDSCH and a second PDSCH out of the second set of PDSCH to be assigned to the UE to receive from the first base station and the second base station respectively. Similar to the discussion above, a selection of the first and second PDSCHs can be done based on measuring reference signals. In some aspects, the first base station can assign a first resource set associated with a first set of reference signals of the first base station and a second resource set associated with a second set of reference signals of the second base station. The first base station can transmit the first set of reference signals based on the first resource set to the UE while the second base station can transmit the second set of reference signals based on the second resource set to the UE. The UE can measure combinations that include one reference signal out of the first set of reference signals and one reference signal out of the second set of reference signals simultaneously in measuring periods. For example, the UE can measure a first reference signal out of the first set of reference signals and a second reference signal out of the second set of reference signals during a first measuring period. The UE can also measure other combinations of reference signals in other measuring periods. If the first set of reference signals includes three reference signals and the second set of reference signals includes three reference signals, the UE can measure a total of 9 combinations of the reference signals. After the UE measures all the combinations, the UE reports measurement results of all the combinations to the first base station. The first base station assigns the first PDSCH and the second PDSCH to the UE based on the measurement results. For example, the combination of the first reference signal and the second signal may have higher RSRPs than all other combinations. In such a case, the first base station may determine that the first combination represents the best channel of simultaneous receiving from among the 9 combinations. The first base station then determines that the first reference signal is QCLed with the first PDSCH and the second reference signal is QCLed with the second PDSCH and thus assigns the first PDSCH and the second PDSCH to the UE.

In some aspects, the UE reports measuring results of a combination of reference signals based on a reporting configuration received from the first base station. For example, the first base station may configure the UE to report measuring results of two CSI-RS or two SSB signals, but not a combination of a CSI-RS and a SSB signal. In such a case, if the first set of reference signals are CSI-RS and the second reference signals are SSB signals, the UE cannot report the measuring results of the combinations as a group to the first base station based on the reporting configuration. Instead, the UE may report the measuring results separately, not as combinations. As a result, the first base station cannot assign the first PDSCH and the second PDSCH to the UE to perform simultaneous receiving as discussed above because the first base station assumes that the UE measures the first set and the second set of reference signals separately in different times. In some aspects, to improve this reporting process, the first base station can configure the UE to perform a group based report for a combination of different types of reference signals. For example, the first base station can include a reporting quantity in the reporting configuration and send it to the UE. The reporting quantity can indicate a combination of CSI-RS and SSB signals.

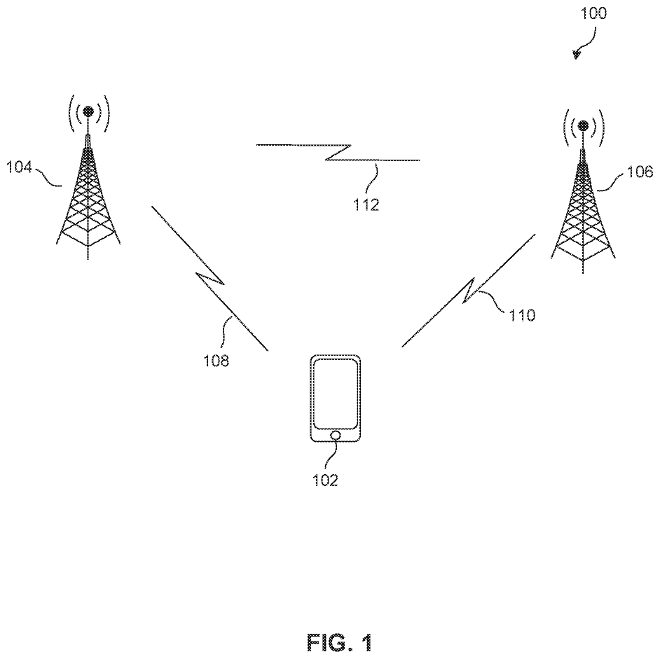

FIG. 1 illustrates an example system 100 implementing a group based CSI reporting procedure for NR systems, according to some aspects of the disclosure. The example system 100 is provided for the purpose of illustration only and does not limit the disclosed aspects. The example system 100 may include, but is not limited to, a UE 102, a base station 104, and a base station 106. The UE 102 may be implemented as electronic devices configured to operate based on a wide variety of wireless communication techniques. These techniques may include, but are not limited to, techniques based on 3rd Generation Partnership Project (3GPP) standards. For example, the UE 102 may be configured to operate using one or more 3GPP releases, such as Release 15 (Rel-15), Release 16 (Rel-16), Release 17 (Rel-17), Release 18 (Rel-18), or other 3GPP releases. The UE 102 may include, but is not limited to, wireless communication devices, smartphones, laptops, desktops, tablets, personal assistants, monitors, televisions, wearable devices, Internet of Things (IoT) devices, vehicle communication devices, and the like. The base stations 104 and 106 may include one or more nodes configured to operate based on a wide variety of wireless communication techniques such as, but not limited to, techniques based on the 3GPP standards. For example, the base stations 104 and 106 may include nodes configured to operate using Rel-15, Rel-16, Rel-17, Rel-18, or other 3GPP releases. The base stations 104 and 106 may include, but not limited to, NodeBs, evolved NodeBs (eNodeBs), next generation NodeBs (gNBs), new radio base stations (NR BSs), access points (APs), remote radio heads, relay stations, transmission/reception points (TRPs), and others.

In some aspects, the UE 102 connects with the base station 104 via a communication link 108. The communication link 108 can include uplink (UL) connections and downlink (DL) connections. Similarly, the UE 102 connects with the base station 106 via a communication link 110. In some aspects, the base station 104 connects with the base station 106 via a communication link 112. The communication link 112 can be a wireless connection or a wired connection via backhaul networks.

In some aspects, UE 102 is capable of receiving signals from the base station 104 and the base station 106 simultaneously. For example, the UE 102 may include two or more receiving chains. The UE 102 may include two transceivers with two corresponding antennas. In such a case, the UE 102 can receive from the base station 104 using the first receiving chain while receiving from the base station 106 using the second receiving chain. In some aspects, the UE 102 can report to the base station 104 or a network controller that controls the base stations 104 and 106 that the UE 102 includes two or more receiving chains. For example, the UE 102 can generate a capability report and transmit it to the base station 104. The capability report indicates that the UE 102 includes two or more receiving chains and thus is capable of receiving signals from the base stations 104 and 106 at the same time. In such a case, the base station 104 or the network controller may assign multiple DL channels to the UE 102 to perform simultaneous receiving from the base stations 104 and 106.

In some aspects, the base station 104 assigns DL channels to the UE 102 based on channel conditions. For example, the base station 104 can transmit signals to the UE 102 via one DL channel out of a first set of DL channels, such as a first set of PDSCHs. Similarly, the base station 106 can transmit signals to the UE 102 via one DL channel out of a second set of DL channels, such as a second set of PDSCHs. In order to determine which DL channels to assign to the UE 102, the base station 104 can assign a first resource set and a second resource set to the UE 102 so that the UE 102 can receive reference signals. For example, the UE 102 can receive a first set of reference signals from the base station 104 based on the first resource set and receive a second set of reference signals from the base station 106 based on the second resource set. In some aspects, the first set of reference signals are respectively QCLed with the first set of DL channels and the second set of reference signals are respectively QCLed with the second set of DL channels. Thus, by measuring the first and the second sets of reference signals, the UE 102 can measure channel conditions of the first and the second sets of DL channels. In some aspects, the UE 102 measures the first and the second set of reference signals by pairs (in combinations). For example, the first set of reference signals may include a first and third reference signals and the second set of reference signals may include a second and fourth reference signals. In such a case, the UE 102 can measure four pairs of reference signals. First, the UE 102 can measure the first and the second reference signals in a first measuring period. Second, the UE 102 can measure the first and the fourth reference signals in a second measuring period. Third, the UE 102 can measure the third and the second reference signals in a third measuring period. Fourth, the UE 102 can measure the third and the fourth reference signals in a fourth measuring period. After measuring all the combinations, the UE 102 can report measuring results to the base station 104 for each combination. The base station 104 can determine a pair of DL channels to assign to the UE 102 based on the measuring results. For example, the base station 104 can determine that the pair of the first and the second reference signals indicates a better channel conditions than other pairs. The pair of the first and the second reference signals may have a higher average RSRP when compared with other pairs. In such a case, the base station 104 can assign a first DL channel out of the first set of DL channels and a second DL channel out of the second set of DL channels to the UE 102. The first DL channel is QCLed with the first reference signal and the second DL channel is QCLed with the second reference signal. As assigned with the first and the second DL channels, the UE 102 can receive signals from the base station 104 on the first DL channel while receiving signals from the base station 106 on the second DL channel.

In some aspects, the UE 102 reports the measurement results to the base station 104 based on configurations received from the base station 104. For example, the base station 104 can transmit a report quantity configuration to the UE 102. The report quantity configuration may indicate a combination of types of reference signals that can be reported as combinations. For example, the report quantity configuration may indicate a combination of two CSI-RS, a combination of two SSB signals, or a combination of a CSI-RS and a SSB signal. If the first set of reference signals are CSI-RS and the second set of reference signals are SSB signals and if the report quantity configuration indicates the combination of a CSI-RS and a SSB signal, the UE 102 can report the measuring results as combinations as discussed above. However, if the report quantity configuration indicates the combination of two CSI-RS or the combination of two SSB signals, the UE 102 cannot report the measuring results of CSI-RS and SSB signals as combinations. Instead, the UE 102 needs to report measuring results separately, although they are measured simultaneously. For another example, the report quantity configuration may indicate a combination of two CSI-RS and if the first set of reference signals and the second set of reference signals are both CSI-RS, the UE 102 can report the measurement results as the combination of CSI-RS as discussed above. For yet another example, the report quantity configuration may indicate a combination of two SSB signals and if the first set of reference signals and the second set of reference signals are both SSB signals, the UE 102 can report the measurement results as the combination of SSB signals as discussed above.

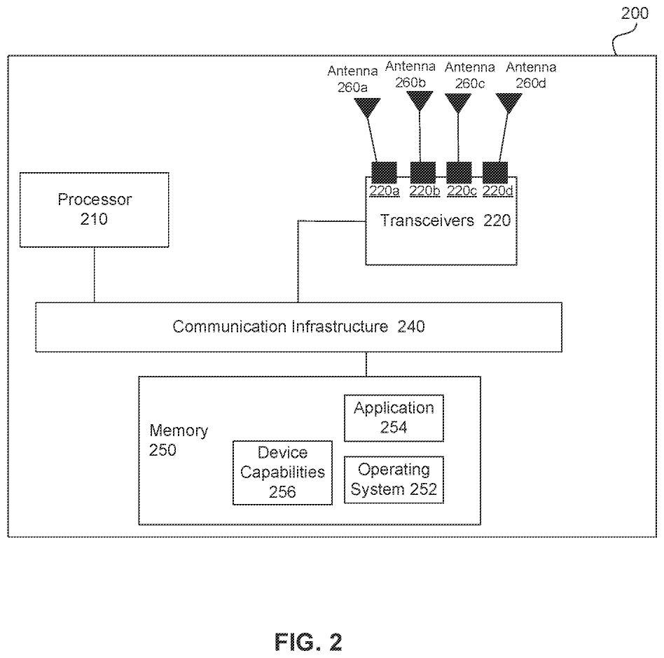

FIG. 2 illustrates a block diagram of an electronic device 200 implementing the group based CSI reporting procedure for NR systems, according to some aspects of the disclosure. The electronic device 200 may be any of the electronic devices (e.g., the UE 102 and the base stations 104 and 106) of the system 100. The electronic device 200 includes a processor 210, one or more transceivers 220, a communication infrastructure 240, a memory 250, an operating system 252, an application 254, device capabilities 256, and antennas 260a, 260b, 260c and 260d. Illustrated systems are provided as exemplary parts of electronic device 200, and electronic device 200 may include other circuit(s) and subsystem(s). Also, although the systems of electronic device 200 are illustrated as separate components, the aspects of this disclosure may include any combination of these, e.g., less, or more components.

The memory 250 may include random access memory (RAM) and/or cache, and may include control logic (e.g., computer software) and/or data. The memory 250 may include other storage devices or memory. According to some examples, the operating system 252 may be stored in the memory 250. The operating system 252 may manage transfer of data from the memory 250 and/or the one or more applications 254 to the processor 210 and/or the one or more transceivers 220. In some examples, the operating system 252 maintains one or more network protocol stacks (e.g., Internet protocol stack, cellular protocol stack, and the like) that may include a number of logical layers. At corresponding layers of the protocol stack, the operating system 252 includes control mechanisms and data structures to perform the functions associated with that layer.

According to some examples, the application 254 may be stored in the memory 250. The application 254 may include applications (e.g., user applications) used by the electronic device 200 and/or a user of the electronic device 200. The applications in the application 254 may include applications such as, but not limited to, radio streaming, video streaming, remote control, and/or other user applications. In some aspects, the device capabilities 256 may be stored in the memory 250.

The electronic device 200 may also include the communication infrastructure 240. The communication infrastructure 240 provides communication between, for example, the processor 210, the one or more transceivers 220, and the memory 250. In some implementations, the communication infrastructure 240 may be a bus.

The processor 210, alone, or together with instructions stored in the memory 250 performs operations enabling electronic device 200 of the system 100 to implement mechanisms for the group based CSI reporting procedure, as described herein. Alternatively, or additionally, the processor 210 can be “hard coded” to implement mechanisms for the group based CSI reporting procedure, as described herein.

The one or more transceivers 220 transmit and receive communications signals supporting mechanisms for the group based CSI reporting procedure. Additionally, the one or more transceivers 220 transmit and receive communications signals that support mechanisms for measuring communication link(s), generating and transmitting system information, and receiving the system information. According to some aspects, the one or more transceivers 220 may include transceivers 220a, 220b, 220c, and 220d that are coupled to the antennas 260a, 260b, 260c, and 260d respectively to wirelessly transmit and receive the communication signals. In some aspects, the one or more transceivers 220 may form one or more receiving chains. For example, the transceiver 220a (having a first receiver) and the antenna 260a can form a first receiving chain. The transceiver 220b (having a second receiver) and the antenna 260b can form a second receiving chain. The antennas 260a, 260b, 260c, and 260d may include one or more antennas that may be the same or different types and can form one or more antenna ports. The one or more transceivers 220 allow electronic device 200 to communicate with other devices that may be wired and/or wireless. In some examples, the one or more transceivers 220 may include processors, controllers, radios, sockets, plugs, buffers, and like circuits/devices used for connecting to and communication on networks. According to some examples, the one or more transceivers 220 include one or more circuits to connect to and communicate on wired and/or wireless networks.

According to some aspects of this disclosure, the one or more transceivers 220 may include a cellular subsystem, a WLAN subsystem, and/or a Bluetooth™ subsystem, each including its own radio transceiver and protocol(s) as will be understood by those skilled in the arts based on the discussion provided herein. In some implementations, the one or more transceivers 220 may include more or fewer systems for communicating with other devices.

In some examples, the one or more the transceivers 220 may include one or more circuits (including a WLAN transceiver) to enable connection(s) and communication over WLAN networks such as, but not limited to, networks based on standards described in IEEE 802.11.

Additionally, or alternatively, the one or more the transceivers 220 may include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, the transceiver 220 may include a Bluetooth™ transceiver.

Additionally, the one or more the transceivers 220 may include one or more circuits (including a cellular transceiver) for connecting to and communicating on cellular networks. The cellular networks may include, but are not limited to, 3G/4G/5G networks such as Universal Mobile Telecommunications System (UMTS), Long-Term Evolution (LTE), and the like. For example, the one or more transceivers 220 may be configured to operate according to one or more of Rel-15, Rel-16, Rel-17, Rel-18, or other releases of 3GPP standard.

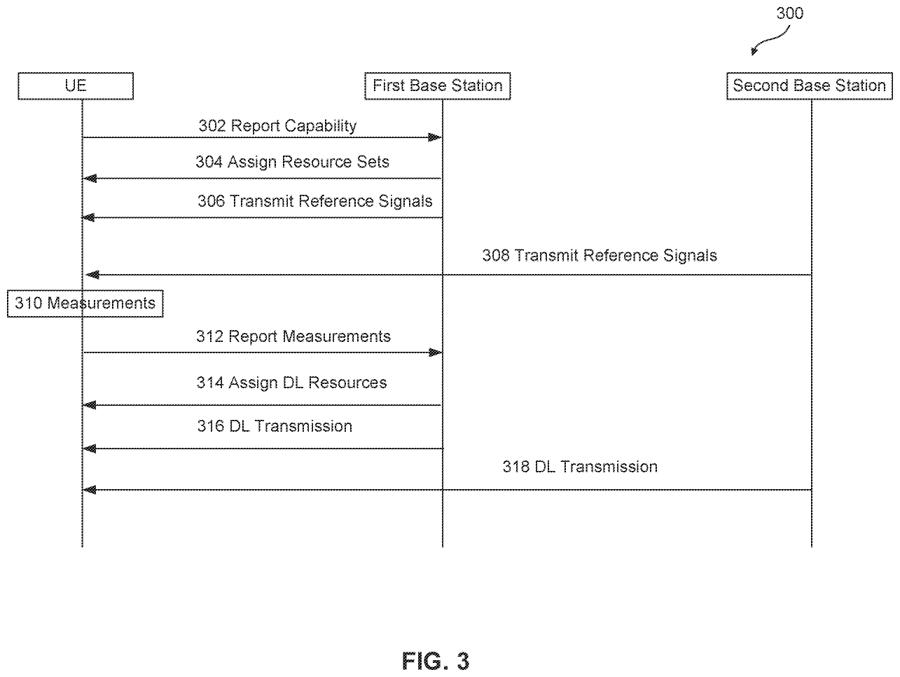

As discussed in more detail below with respect to FIGS. 3-8, processor 210 may implement different mechanisms for the reference signal configuration procedure as discussed with respect to the system 100 of FIG. 1.

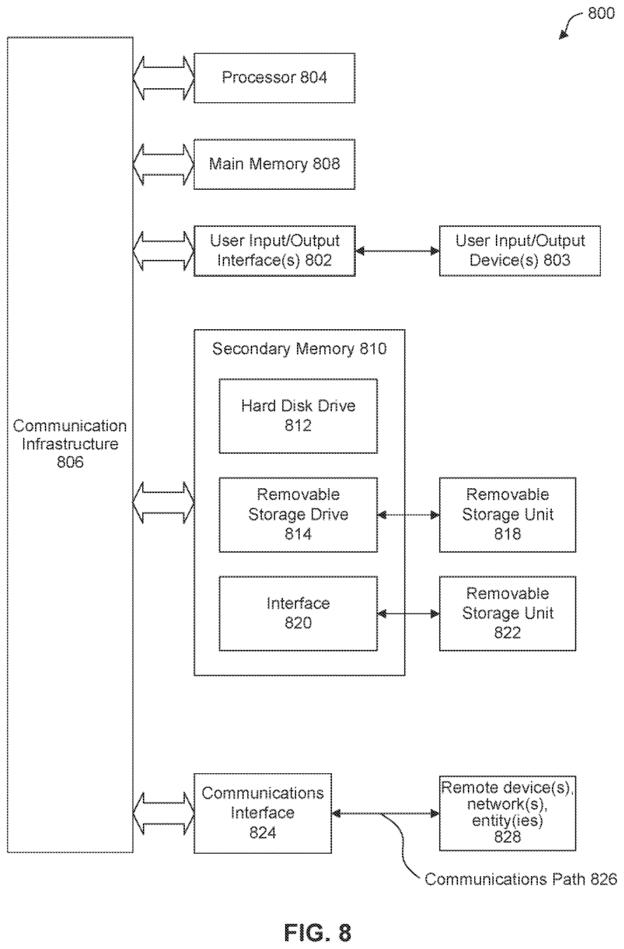

FIG. 3 illustrates an example method 300 of the group based CSI reporting procedure. The example method 300 is provided for the purpose of illustration only and does not limit the disclosed aspects. As a convenience and not a limitation, FIG. 3 may be described with regard to elements of FIGS. 1, 2, and 8. The example method 300 may represent the operation of electronic devices (for example, the UE 102 and the base stations 104 and 106 of FIG. 1) implementing the group based CSI reporting procedure. The example method 300 may also be performed by the electronic device 200 of FIG. 2, controlled or implemented by processor 210, and/or computer system 800 of FIG. 8. But the example method 300 is not limited to the specific aspects depicted in those figures and other systems may be used to perform the method, as will be understood by those skilled in the art. It is to be appreciated that not all operations may be needed, and the operations may not be performed in the same order as shown in FIG. 3.

At 302, a UE, such as the UE 102 in FIG. 1, transmits a capability report to a first base station, such as the base station 104 in FIG. 1. The capability report may indicate that the UE includes two or more receiving chains. For example, the UE may include the first receiving chain formed by the transceiver 220a and the antenna 260a and the second receiving chain formed by the transceiver 220b and the antenna 260b in FIG. 2. In such a case, the UE is capable of receiving signals from the first base station and a second base station, such as the base station 104 and the base station 106 of FIG. 1, at the same time. In some aspects, the capability report may indicate that the UE is capable of receiving two sets of reference signals from two respective base stations, such as the first and the second base stations, simultaneously during a measuring period.

At 304, the first base station assigns resource sets to the UE. In some aspects, the resource sets include a first resource set associated with the first base station and a second resource set associated with the second base station. Furthermore, the first resource set and the second resource set can be associated with a first set of reference signals and a second set of reference signals respectively. For example, the first resource set can be associated with a set of CSI-RS and the second resource set can be associated with a set of SSB signals. Thus, by assigning the first and the second resource sets to the UE, the first base station configures the UE to receive the set of CSI-RS from the first base station and the set of SSB signals from the second base station. In some aspects, the first base station can transmit a configuration message to the UE. The configuration message indicates that the first resource set associated with the first base station and the second resource set associated with the second base station are assigned to the UE. In some aspects, the first base station can transmit the configuration message or information of the second resource set to the second base station via a communication link, such as the communication link 110 of FIG. 1, so that the second base station is configured to transmit the set of SSB signals to the UE using the second resource set. In other aspects, a network controller that controls the first base station and the second base station determines the first and the second resource sets. In such a case, the network controller may transmit information of the first and the second resource sets to the first and the second base stations via backhaul connections and thus there is no need for the first base station to transmit the configuration message or the information of the second resource set to the second base station.

At 306, the first base station transmits the first set of reference signals to the UE. As discussed above, the first set of reference signals can be the set of CSI-RS. In some aspects, the first base station transmits the first set of reference signals based on the first resource set. For example, the first resource set includes a first radio resource and a third radio resource and the first set of reference signals includes a first reference signal and a third reference signal. In some aspects, radio resources, such as the first and the third radio resources, indicate frequency bands and time intervals for transmission. In such a case, the first base station transmits the first reference signal using the first radio resource and transmits the third reference signal using the third radio resource to the UE.

At 308, the second base station transmits the second set of reference signals to the UE. As discussed above, the second set of reference signals can be the set of SSB signals. In some aspects, the second base station transmits the second set of reference signals based on the second resource set. For example, the second resource set includes a second radio resource and a fourth radio resource and the second set of reference signals includes a second reference signal and a fourth reference signal. In such a case, the second base station transmits the second reference signal using the second radio resource and transmits the fourth reference signal using the fourth radio resource. In some aspects, the second base station transmits the second set of reference signals while the first base station transmits the first set of reference signals to the UE. Phrased differently, the UE receives the first set of reference signals from the first base station during a measuring period and receives the second set of reference signals during the measuring period simultaneously.

At 310, the UE measures received reference signals. Because the first base station and the second base station transmit at the same time in steps 306 and 308, the UE can measure reference signals from the first base station and the second base station simultaneously in combinations. For example, the UE can perform a first measurement on the first reference signal from the first base station and the second reference signal from the second base station during a first measuring period. The UE can perform a second measurement on the first reference signal from the first base station and the fourth reference signal from the second base station during a second measuring period. The UE can perform a third measurement on the third reference signal from the first base station and the second reference signal from the second base station during a third measuring period. Finally, the UE can perform a fourth measurement on the third reference signal from the first base station and the fourth reference signal from the second base station during a fourth measuring period. In some aspects, the UE can receive and measure reference signals from the first and the second base stations using respective transceivers. For example, the UE can receive and measure the first reference signal or the third reference signal using a first transceiver, such as the transceiver 220a in FIG. 2. Similarly, the UE can receive and measure the second reference signal or the fourth reference signal using a second transceiver, such as the transceiver 220b in FIG. 2. Because the transceivers 220a and 220b form different respective receiving chains as discussed above, the UE can receive and measure different reference signals using the first and the second transceivers, simultaneously.

In some aspects, the UE can measure various quantities of reference signals. For example, the UE can measure RSRP, SINR, or other quantities of the first set and the second set of reference signals. Specifically, the UE can measure RSRP of the first set of reference signals and SINR of the second set of reference signals, SINR of the first set of reference signals and RSRP of the second set of reference signals, RSRP of the first and the second sets of reference signals, SINR of the first and the second sets of reference signals, or other combinations. In some aspects, the quantities of reference signals to be measured can be configured by the first base station. For example, the first base station can indicate in the configuration message transmitted to the UE at 304 that the UE measures a first quantity, such as RSRP or SINR, of the first set of reference signals based on the first resource set and measures a second quantity, such as RSRP or SINR, of the second reference signals based on the second resource set. In some aspects, the first base station can also configure the quantities of reference signals to be measured in an additional configuration message that is different from the configuration message discussed at 304.

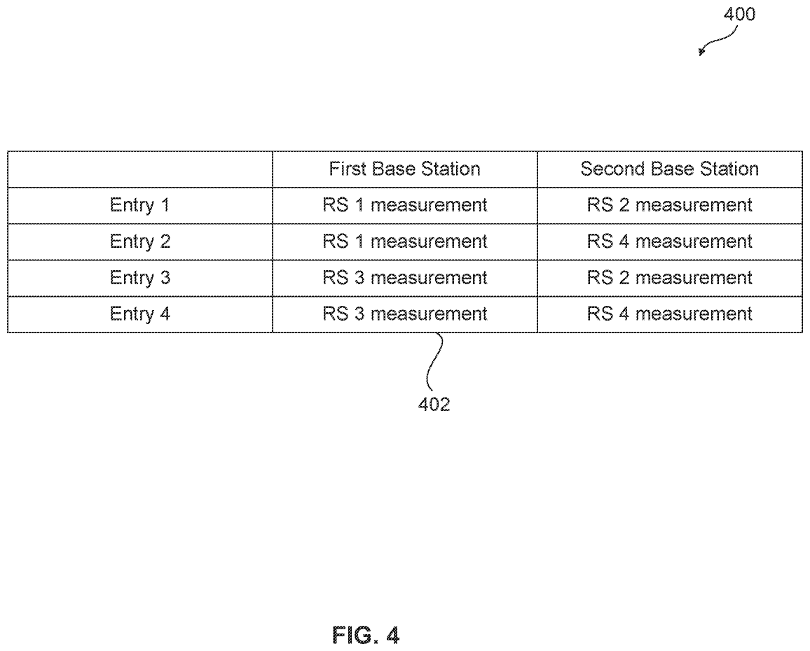

At 312, the UE reports results of measurements to the first base station. For example, the UE reports results of the all four measurements discussed in 310 to the first base station as combinations. In some aspects, the UE reports the results of measurements based on configuration received from the first base station. For example, the first base station can indicate a report quantity parameter in the configuration message discussed in 304 or a separate configuration message. The report quantity parameter can configure the UE to report a combination of reference signal types. For example, the report quantity parameter can indicate a combination of two CSI-RS, a combination of two SSB signals, or a combination of a CSI-RS and a SSB signal. In some aspects, the report quantity parameter can further indicate quantities of measurements discussed in 310. For example, the combination of a CSI-RS and a SSB signal can further include four options: (1) CSI-RS RSRP+SSB RSRP, (2) CSI-RS SINR+SSB RSRP, (3) CSI-RS SINR+SSB SINR, and (4) CSI-RS RSRP+SSB SINR. In such a case, if the report quantity parameter indicates the combination of a CSI-RS and a SSB signal with the option (1) and the first resource set and the second resource set are associated with CSI-RS and SSB signals respectively, the UE measures RSRP of the first set of reference signals and measures SINR of the second set of reference signals. The UE then performs a combined CSI reporting to report results of measurement in a reporting list as a group, which is discussed further in FIG. 4 below. By including the results of measurement of the first set of reference signals and the second set of reference signals in one reporting list as a group, the UE indicates to the first base station that the first set of reference signals and the second set of reference signals are measured simultaneously. In some aspects, the UE performs the combined CSI reporting using one of multiple transceivers of the UE. For example, the UE can transmit the reporting list to the first base station using the transceiver 220a.

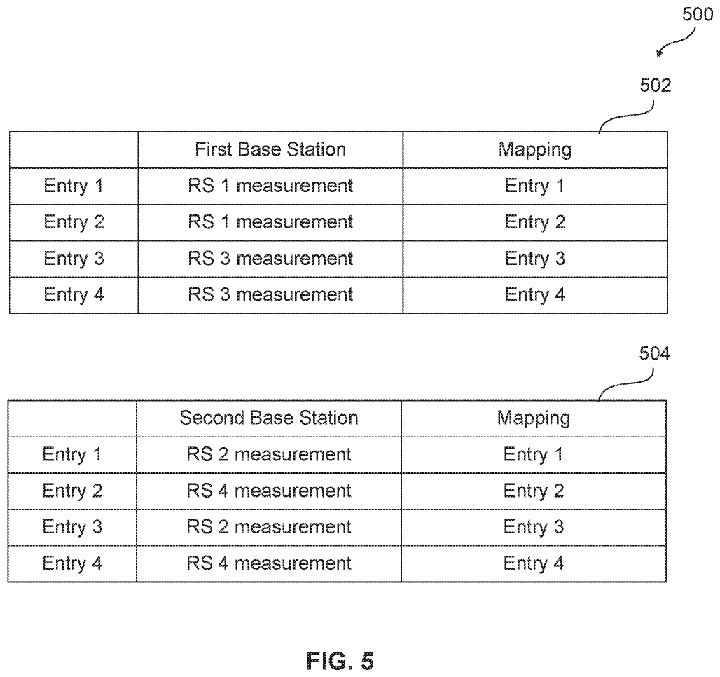

In some aspects, the report quantity parameter does not match configured resource sets, such as the first and the second resource sets. For example, the first resource set and the second resource set may be associated with CSI-RS and SSB signals respectively. However, the report quantity parameter may indicate a combination of two CSI-RS. In such a case, the UE cannot report the results of measuring the first set of reference signals and the second set of reference signals as a group. Alternatively, the UE can report the results measuring the first set of reference signals and the second set of reference signals in separate reporting lists but indicates connections between the reporting lists, as discussed further in FIG. 5 below. In such a case, the UE can indicate to the first base station that the first set of reference signals and the second set of reference signals are measured simultaneously and thus are associated in time. In some aspects, the UE performs the separated CSI reporting using one of multiple transceivers of the UE. For example, the UE can transmit the separate reporting lists to the first base station using the transceiver 220a.

In other aspects, the UE may measure the first set of reference signals and the second set of reference signals in different time periods if the report quantity parameter does not match configured resource sets. Phrased differently, although the first base station assigns the first and the second resource sets to the UE to perform simultaneous measurement as discussed in 304, since the first base station does not configure a corresponding report quantity parameter for reporting as such, the UE can ignore the assigned resource sets and measure reference signals from the first and the second base stations in different time periods.

In some aspects, the first base station may have restrictions when configuring the UE. If the first base station configures the UE to report measuring results of two sets of reference signals of a same type, such as two sets of CSI-RS or two sets of SSB signals, the first base station is restricted from configuring two resource sets to transmit and receive two set of reference signals of different types, such as a set of CSI-RS and a set of SSB signals, to the UE. The configuration of measurement reporting needs to be consistent with the configuration of resource sets for reference signals transmission. For example, if the first base station configures a reporting quantity parameter to indicate a combination of two CSI-RS or a combination of two SSB signals, the first base station is restricted to assign a first resource set associated with a set of CSI-RS and a second resource set associated with a set of SSB signals to the UE. This is because if the UE is assigned with such resource sets, the UE may perform simultaneous measurements based on the two resource sets as discussed above. For example, the UE may measure the set of CSI-RS received from the first base station using the first resource set while measuring the set of SSB signals received from the second base station. Such simultaneous measurements consume more energy when compared with measuring the set of CSI-RS and the set of SSB signals separately at different times. If the UE cannot report that the measurement results were measured simultaneously, the additional energy consumption is wasted. Such waste of energy may occur if the UE is configured with the reporting quantity parameter that indicates a combination of two CSI-RS or a combination of two SSB signals. In such a case, the UE cannot report results of simultaneous measurements as a group. Thus, to avoid such a waste of energy, the first base station is restricted from configuring two resource sets of the reference signals of different types to the UE if the first base station does not configure the UE to report measuring results of two sets of reference signals of different types as a group.

At 314, the first base station assigns DL resources to the UE. In some aspects, the first base station assigns the DL resources based on the measurement results reported in 312. For example, the first base station may determine that the result of the first measurement discussed in 310 indicates better channel conditions compared with other measurements. Thus, the first base station may assign a first DL resource that is QCLed with the first reference signal and a second DL resource that is QCLed with the second reference signal to the UE. In some aspects, the first and the second DL resources can be PDSCHs. The first base station can transmit a DL resource assignment message to the UE that indicates the first and the second DL resources. In some aspects, the first base station may also transmit the DL resource assignment message or information of the second DL resource to the second base station so that the second base station is configured to perform DL transmission using the second DL resource. In other aspects, the first base station may forward the measurement results reported in 312 to the network controller and the network controller determines the first DL resource and the second DL resource. In such a case, the network controller may notify the first base station information of the first DL resource and notify the second base station the information of the second DL resource via backhaul connections.

At 316, the first base station performs a first DL transmission on the first DL resource to the UE. At 318, the second base station performs a second DL transmission on the second DL resource to the UE. In some aspects, the first DL transmission and the second DL transmission occur at the same time.

FIG. 4 illustrates an example 400 of a combined CSI report. The example 400 is provided for the purpose of illustration only and does not limit the disclosed aspects. As a convenience and not a limitation, FIG. 4 may be described with regard to elements of FIGS. 1, 2, and 8. The example 400 may represent the operation of electronic devices (for example, the UE 102 and the base stations 104 and 106 of FIG. 1) implementing the group based CSI reporting. The example 400 may also be performed by the electronic device 200 of FIG. 2, controlled or implemented by processor 210, and/or computer system 800 of FIG. 8. But the example 400 is not limited to the specific aspects depicted in those figures and other systems may be used to perform the method, as will be understood by those skilled in the art. It is to be appreciated that not all operations may be needed, and the operations may not be performed in the same order as shown in FIG. 4.

In some aspects, the example 400 includes a reporting list 402. The UE can generate the reporting list 402 and transmits it to the first base station, as discussed in 312 of FIG. 3. The reporting list 402 includes four entries: Entry 1, Entry 2, Entry 3, and Entry 4. The four entries correspond to the four measurements discussed in 310 of FIG. 3. Specifically, the Entry 1 includes “RS 1 measurement” and “RS 2 measurement” that correspond to the first measurement of the first reference signal and the second reference signal during the first measuring period; the Entry 2 includes “RS 1 measurement” and “RS 4 measurement” that correspond to the second measurement of the first reference signal and the fourth reference signal during the second measuring period; the Entry 3 includes “RS 3 measurement” and “RS 2 measurement” that correspond to the third measurement of the third reference signal and the second reference signal during the third measuring period; and the Entry 4 includes “RS 3 measurement” and “RS 4 measurement” that correspond to the fourth measurement of the third reference signal and the fourth reference signal during the fourth measuring period. In some aspects, the reporting list 402 may include more or fewer entries. A number of entries in the reporting list 402 depends on a first number of reference signals in the first set of reference signals and a second number of reference signals in the second set of reference signals. For example, the first set of reference signals may include x number of reference signals, i.e., the first number=x, and the second set of reference signals may include y number of reference signals, i.e., the second number of y. In such a case, the number of entries in the reporting list 402 can be x times y so that the reporting list 402 includes all the combinations of the first and the second sets of reference signals.

In some aspects, the UE measures reference signals and generates measurement results in each entry based on a configuration received from the first base station, as discussed in 310 and 312 of FIG. 3. For example, if the report quantity parameter indicates the option (1) that is discussed in 312 of FIG. 3, the first base station transmits a first and a second CSI-RS to the UE and the second base station transmits a first and a second SSB signals to the UE. The UE can measure RSRP of the first CSI-RS and RSRP of the first SSB signal simultaneously in the first measuring period to generate the “RS 1 measurement” and the “RS 2 measurement” respectively in the Entry 1. Similarly, the UE measures RSRP of the first CSI-RS and RSRP of the second SSB signal in the second measurement period to generate the “RS 1 measurement” and the “RS 4 measurement” respectively in the Entry 2. In some aspects, the Entry 1 and Entry 2 include their respective RS 1 measurements that may have different values. This is because the “RS 1 measurement” in the Entry 1 is obtained by measuring the first CSI-RS while measuring the first SSB signals. In contrast, the “RS 1 measurement” in the Entry 2 is obtained by measuring the first CSI-RS while measuring the second SSB signal. Here, the term “RS 1 measurement” is used to indicate a measurement of the first CSI-RS, which can vary based on other reference signals that are measured at the same time. Similarly, the term “RS 2 measurement” indicates a measurement of the first SSB signal; the term “RS 3 measurement” indicates a measurement of the second CSI-RS; and the term “RS 4 measurement indicates a measurement of the second SSB signal.

In some aspects, the first base station can determine which entry represents strongest channels based on the reporting list 402. For example, the first base station can determine an average measurement value of each entry and select the entry with a highest average measurement value. The first base station can determine a first average measurement value of the entry 1 to be (RS 1 measurement+RS 2 measurement)/2. The first base station can also similarly determine a second average measurement value of the Entry 2, a third average measurement value of the Entry 3, and a fourth average measurement value of the Entry 4. The first base station may then determine that the first average measurement value is the highest. In such a case, the first base station can assign DL resources as discussed in 314 of FIG. 3 based on the Entry 1. For example, if the report quantity parameter indicates the option (1), the first base station can assign a first DL resource that is QCLed with the first CSI-RS and a second DL resource that is QCLed with the first SSB signal to the UE. In such a case, the first base station performs the DL transmission using the first DL resource in 316 of FIG. 3 and the second base station performs the DL transmission using the second DL resource in 318 of FIG. 3. In some aspects, the first base station can determine which entry represents strongest channels based on measurement values of the first base station, i.e., values in the column of “First Base Station” in the reporting list 402. For example, the first base station may determine that the “RS 1 measurement” of the Entry 1 is larger than measurements in the “First Base Station” column of any other entries. In such a case, the first base station can assign DL resources as discussed in 314 of FIG. 3 based on the Entry 1. Note that in this case, the “RS 2 measurement” of the Entry 1 may be smaller than measurements in the “Second Base Station” column of other entries. In other aspects, the first base station can also determine which entry represents strongest channels by determining which entry includes a strongest second base station measurement result, a highest minimum measurement value, a highest maximum measurement value, or a highest difference value in the measurement values. For example, the first base station can determine which entry represents strongest channels based on measurement values of the second base station, i.e., values in the column of “Second Base Station” in the reporting list 402. For another example, the first base station can determine which entry represents strongest channels based on a minimal value of each entry. A minimal value of the Entry 1 is the minimal of “RS 1 measurement” and “RS 2 measurement” in the Entry 1. If the minimal value of the Entry 1 is higher than minimal values of other entries, Entry 1 represents the strongest channels and the first base station assigns the first and the second DL resources based on the Entry 1. For yet another example, the first base station can determine which entry represents strongest channels based on difference values of each entry. A difference value of the Entry 1 is an absolute value of “RS 1 measurement”−“RS 2 measurement” in the Entry 1. If the difference value of the Entry 1 is higher than difference values of other entries, Entry 1 represents the strongest channels and the first base station assigns the first and the second DL resources based on the Entry 1.

FIG. 5 illustrates an example 500 of separate CSI reports. The example 500 is provided for the purpose of illustration only and does not limit the disclosed aspects. As a convenience and not a limitation, FIG. 5 may be described with regard to elements of FIGS. 1, 2, and 8. The example 500 may represent the operation of electronic devices (for example, the UE 102 and the base stations 104 and 106 of FIG. 1) implementing the group based CSI reporting. The example 500 may also be performed by the electronic device 200 of FIG. 2, controlled or implemented by processor 210, and/or computer system 800 of FIG. 8. But the example 500 is not limited to the specific aspects depicted in those figures and other systems may be used to perform the method, as will be understood by those skilled in the art. It is to be appreciated that not all operations may be needed, and the operations may not be performed in the same order as shown in FIG. 5.

In some aspects, the example 500 includes a reporting list 502 and reporting list 504. The UE may transmit the reporting list 502 and the reporting list 504 via separate signaling to the first base station. In some aspects, entries of the reporting lists 502 and 504 include same measurement results as the reporting list 402 of FIG. 4. For example, “RS 1 measurement” of Entry 1 of the reporting list 502 and “RS 2 measurement” of Entry 1 of the reporting list 504 are the same as the “RS 1 measurement” and the “RS 2 measurement” of the Entry 1 of the reporting list 402 of FIG. 4. However, if the report quantity parameter indicates a combination of two CSI-RS or a combination of two SSB signals, not a combination of a CSI-RS and a SSB signal, the UE cannot perform a combined CSI report as discussed in FIG. 4. Instead, the reporting list 402 is divided into two separate reporting lists: the reporting list 502 and the reporting list 504. The reporting list 502 includes measurement results of reference signals from the first base station and the reporting list 504 includes measurement results of reference signals from the second base station. However, the UE may have measured the reference signals from the first base station and the second base station at the same time. For example, the “RS 1 measurement” of the Entry 1 of the reporting list 502 and the “RS 2 measurement” of the Entry 1 of the reporting list 504 may be measured at the same time. Thus, to indicate that measurement results in the reporting list 502 and the reporting list 504 are associated in time, either or both reporting lists 502 and 504 indicate the other reporting list. For example, the reporting list 502 can include or indicate an identification of the reporting list 504. Similarly, the reporting list 504 can include or indicate an identification of the reporting list 502. In some aspects, the UE can generate and transmit an additional report to the first base station. The additional report indicates that the reporting list 502 and the reporting list 504 are associated in time. For example, the additional report can include the identification of the reporting list 502 and the identification of the reporting list 504. The additional report can further indicate that the identifications of the reporting lists 502 and 504 are associated in time by placing them in a same entry or explicitly stating so. Furthermore, each entry of the reporting list 502 and the reporting list 504 indicates an associated entry of the other reporting list. For example, Entries 1, 2, 3, and 4 in the reporting list 502 include mapping parameters “Entry 1,” “Entry 2,” “Entry 3,” and “Entry 4,” respectively. Thus, the first base station can determine that the entries 1, 2, 3, and 4 of the reporting list 502 were measured at the same time with Entries 1, 2, 3, and 4 of the reporting list 504. In such a case, the first base station can combine the reporting lists 502 and 504 to form the reporting list 402 of FIG. 4. The first base station can then determine the DL resources to be assigned to the UE as discussed above. In some aspects, the reporting lists 502 and 504 may not include the mapping parameters as discussed above. In such a case, the first base station can assume that entries in both reporting lists are matched by their order in the reporting lists. For example, a first entry of the reporting list 502, i.e., Entry 1, is associated in time with a first entry of the reporting list 504, i.e., Entry 1; a second entry of the reporting list 502, i.e., Entry 2, is associated in time with a second entry of the reporting list 504, i.e., Entry 2; and so on.

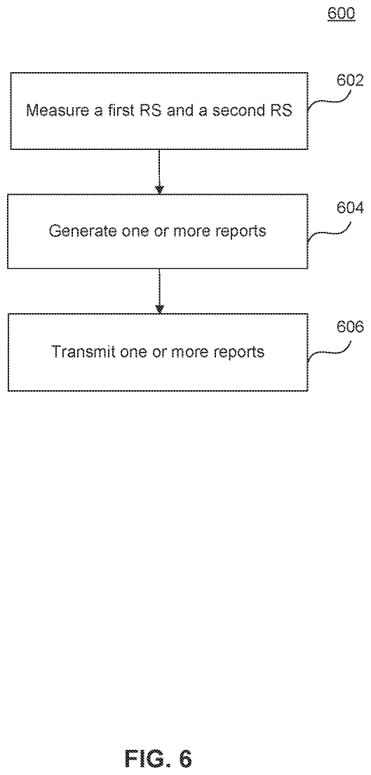

FIG. 6 illustrates an example method 600 of the group based CSI reporting procedure at a UE, according to aspects of the disclosure. The example method 600 is provided for the purpose of illustration only and does not limit the disclosed aspects. As a convenience and not a limitation, FIG. 6 may be described with regard to elements of FIGS. 1, 2, and 8. The example method 600 may represent the operation of electronic devices (for example, the UE 102 and the base stations 104 and 106 of FIG. 1) implementing the group based CSI reporting procedure. The example method 600 may also be performed by the electronic device 200 of FIG. 2, controlled or implemented by processor 210, and/or computer system 800 of FIG. 8. But the example method 600 is not limited to the specific aspects depicted in those figures and other systems may be used to perform the method, as will be understood by those skilled in the art. It is to be appreciated that not all operations may be needed, and the operations may not be performed in the same order as shown in FIG. 6.

At 602, a UE, such as the UE 102 of FIG. 1, measures a first reference signal received from a first base station, such as the base station 104 of FIG. 1, and a second reference signal received from a second base station, such as the base station 106 of FIG. 1. The UE can measure the first reference signal and the second reference signal simultaneously during a measuring period.

At 604, the UE generates one or more reports that include results of measuring the first and the second reference signals. In some aspects, the one or more reports include a combined reporting list, as discussed in FIG. 4, which includes the measuring results of the first and the second reference signals. In some aspects, the one or more reports include two separate reporting lists, as discussed in FIG. 5, that respectively include the measurement result of the first reference signal and the measurement result of the second reference signal.

At 606, the UE transmits the one or more reports to the first base station.

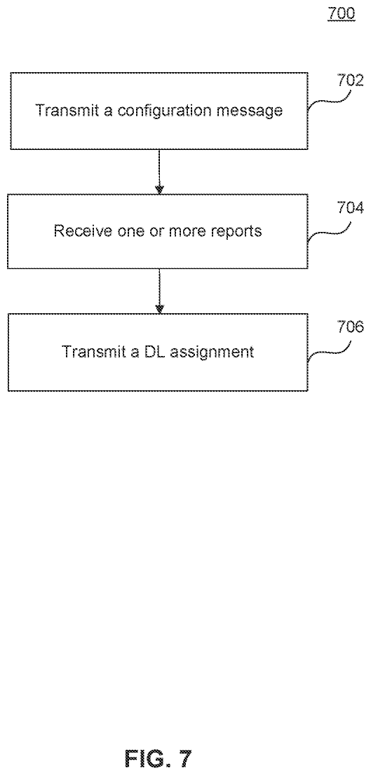

FIG. 7 illustrates an example method 700 of the group based CSI reporting procedure at a base station, according to aspects of the disclosure. The example method 700 is provided for the purpose of illustration only and does not limit the disclosed aspects. As a convenience and not a limitation, FIG. 7 may be described with regard to elements of FIGS. 1, 2, and 8. The example method 700 may represent the operation of electronic devices (for example, the UE 102 and the base stations 104 and 106 of FIG. 1) implementing the group based CSI reporting procedure. The example method 700 may also be performed by the electronic device 200 of FIG. 2, controlled or implemented by processor 210, and/or computer system 800 of FIG. 8. But the example method 700 is not limited to the specific aspects depicted in those figures and other systems may be used to perform the method, as will be understood by those skilled in the art. It is to be appreciated that not all operations may be needed, and the operations may not be performed in the same order as shown in FIG. 7.

At 702, a first base station, such as the base station 104 of FIG. 1, transmits a configuration message to a UE, such as the UE 102 of FIG. 1. The configuration message configures the UE to report a first measuring result of a first reference signal received from the first base station and a second measuring result of a second reference signal received from a second base station. The first measuring result and the second measuring result are measured in a measuring period. In some aspects, the configuration message may configure the UE to report in a combined reporting list, as discussed in FIG. 4. In other aspects, the configuration message may configure the UE to report two separate reporting lists, as discussed in FIG. 5.

At 704, the first base station receives one or more reports that include the first measuring result and the second measuring result. The one or more reports indicate that the first measuring result is associated with the second measuring result in time. In some aspects, the one or more reports include a combined reporting list, as discussed in FIG. 4, that includes the first and the second measuring results. In other aspects, the one or more reports include two separate reporting lists, as discussed in FIG. 5, that respectively include the first and the second measurement results.

At 706, the first base station transmits a DL resource assignment to the UE. The DL resource assignment assigns a first DL resource set and a second DL resource set to the UE. The first DL resource set is associated with the first reference signal and the second DL resource set is associated with the second reference signal. In some aspects, the first base station transmits DL signals to the UE using the first DL resource set while the second base station transmits DL signals to the UE using the second DL resource set.

Various aspects can be implemented, for example, using one or more computer systems, such as computer system 800 shown in FIG. 8. Computer system 800 can be any well-known computer capable of performing the functions described herein such as devices 102, 104, and 106 of FIG. 1, or 200 of FIG. 2. Computer system 800 includes one or more processors (also called central processing units, or CPUs), such as a processor 804. Processor 804 is connected to a communication infrastructure 806 (e.g., a bus.) Computer system 800 also includes user input/output device(s) 803, such as monitors, keyboards, pointing devices, etc., that communicate with communication infrastructure 806 through user input/output interface(s) 802. Computer system 800 also includes a main or primary memory 808, such as random access memory (RAM). Main memory 808 may include one or more levels of cache. Main memory 808 has stored therein control logic (e.g., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 includes a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 reads from and/or writes to removable storage unit 818 in a well-known manner.

According to some aspects, secondary memory 810 may include other means, instrumentalities or other approaches for allowing computer programs and/or other instructions and/or data to be accessed by computer system 800. Such means, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 enables computer system 800 to communicate and interact with any combination of remote devices, remote networks, remote entities, etc. (individually and collectively referenced by reference number 828). For example, communication interface 824 may allow computer system 800 to communicate with remote devices 828 over communications path 826, which may be wired and/or wireless, and which may include any combination of LANs, WANs, the Internet, etc. Control logic and/or data may be transmitted to and from computer system 800 via communication path 826.

The operations in the preceding aspects may be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 800, main memory 808, secondary memory 810 and removable storage units 818 and 822, as well as tangible articles of manufacture embodying any combination of the foregoing. Such control logic, when executed by one or more data processing devices (such as computer system 800), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 8. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A user equipment (UE) comprising:
two or more transceivers configured to enable wireless communications with a first base station; and
a processor, communicatively coupled to the two or more transceivers, and configured to:
measure, using the two or more transceivers, a first reference signal and a second reference signal during a measuring period to determine a first measuring result of the first reference signal and a second measuring result of the second reference signal;
generate one or more reports that include the first measuring result and the second measuring result, wherein the one or more reports indicate that the first measuring result is associated with the second measuring result in time; and
transmit, using one of the two or more transceivers, the one or more reports to the first base station.

2. The UE of claim 1, wherein to measure the first reference signal and the second reference signal during the measuring period, the processor is further configured to:
receive the first reference signal based on a first resource set during the measuring period; and
receive the second reference signal based on a second resource set during the measuring period.

3. The UE of claim 2, wherein the processor is further configured to:
receive a configuration message from the first base station, wherein the configuration message indicates the first resource set and the second resource set.

4. The UE of claim 2, wherein the processor is further configured to:
receive the first reference signal from the first base station; and
receive the second reference signal from a second base station.

5. The UE of claim 1,
wherein the first reference signal includes a channel state information reference signal (CSI-RS), and
wherein the second reference signal includes a synchronization signal block (SSB) signal.

6. The UE of claim 1,
wherein the first measuring result includes a reference signal received power (RSRP) or a signal-to-interference-plus-noise ratio (SINR) of the first reference signal, and
wherein the second measuring result includes a RSRP or a SINR of the second reference signal.

7. The UE of claim 1, wherein to generate the one or more reports, the processor is further configured to:
receive a configuration message from the first base station,
wherein the configuration message configures the processor to generate a report that includes the first measuring result and the second measuring result, and
wherein the report indicates that the first measuring result is associated with the second measuring result in time.

8. The UE of claim 1, wherein to generate the one or more reports, the processor is further configured to:
receive a configuration message from the first base station, wherein the configuration message configures the processor to:
generate a first report that includes the first measuring result; and
generate a second report that includes the second measuring result,
wherein the first report or the second report indicates that the first measuring result is associated with the second measuring result in time.

9. The UE of claim 8, wherein the one or more reports includes a third report indicating that the first measuring result is associated with the second measuring result in time.

10. The UE of claim 1, wherein the processor is further configured to:
transmit a capability report to the first base station, wherein the capability report indicates that the UE is capable of receiving the first reference signal and the second reference signal during the measuring period simultaneously.

11. A method of operating a user equipment (UE) comprising:
measuring a first reference signal and a second reference signal during a measuring period to determine a first measuring result of the first reference signal and a second measuring result of the second reference signal;
generating one or more reports that include the first measuring result and the second measuring result, wherein the one or more reports indicate that the first measuring result is associated with the second measuring result in time; and
transmitting the one or more reports to a first base station.

12. The method of claim 11, wherein the measuring the first reference signal and the second reference signal during the measuring period further comprises:
receiving the first reference signal based on a first resource set during the measuring period; and
receiving the second reference signal based on a second resource set during the measuring period.

13. A base station comprising:
a transceiver configured to enable wireless communication with a user equipment (UE); and
a processor, communicatively coupled to the transceiver, and configured to:
transmit, using the transceiver, a configuration message to the UE, wherein the configuration message configures the UE to report a first measuring result of a first reference signal and a second measuring result of a second reference signal measured in a measuring period;
receive, using the transceiver, one or more reports that include the first measuring result and the second measuring result, wherein the one or more reports indicate that the first measuring result is associated with the second measuring result in time; and
transmit, using the transceiver, a downlink resource assignment to the UE, wherein the downlink resource assignment assigns a first downlink resource set associated with the first reference signal and a second downlink resource set associated with the second reference signal to the UE.

14. The base station of claim 13,
wherein the first reference signal includes a channel state information reference signal (CSI-RS), and
wherein the second reference signal includes a synchronization signal block (SSB) signal.

15. The base station of claim 13,
wherein the first reference signal and the second reference signal have a same reference signal type.

16. The base station of claim 15,
wherein the same reference signal type is a channel state information reference signal (CSI-RS) or a synchronization signal block (SSB) signal.

17. The base station of claim 13,
wherein the first measuring result includes a reference signal received power (RSRP) or a signal-to-interference-plus-noise ratio (SINR) of the first reference signal, and
wherein the second measuring result includes a RSRP or a SINR of the second reference.

18. The base station of claim 13, wherein the configuration message further configures the UE to:
receive the first reference signal based on a first resource set during the measuring period; and
receive the second reference signal based on a second resource set during the measuring period.

19. The base station of claim 18, wherein the processor is further configured to transmit, using the transceiver, the first reference signal to the UE based on the first resource set.

20. The base station of claim 13,
wherein the one or more reports include a first report and a second report,
wherein the first report includes the first measuring result,
wherein the second report includes the second measuring result, and
wherein the first report or the second report indicates that the first measuring result is associated with the second measuring result in time.
